(19) United States
(12) Patent Application Publication
(10) Pub. No.: US 2005/0219056 A1
(43) Pub. Date: Oct. 6, 2005

(54) Method and system for tracking individuals and providing related electronic notifications

(76) Inventors: Daniel McHugh, Plymouth, MI (US); Donald C. Luby JR., Lake Orion, MI (US)

Correspondence Address: HARNESS, DICKEY & PIERCE, P.L.C., P.O. BOX 828, BLOOMFIELD HILLS, MI, 48303, US

(21) Appl. No.: 11/093,810

(22) Filed: Mar. 30, 2005

Related U.S. Application Data
(60) Provisional application No. 60/557,720, filed on Mar. 30, 2004.

(51) Int. Cl. G08B 23/00

(52) U.S. Cl. 340/573.4; 340/994; 235/376; 340/531

(57) ABSTRACT

A method for tracking a plurality of bus riders includes assigning each bus rider with a unique identifier upon boarding a bus to indicate a transportation status and recording the unique identifier upon exiting the bus to update the transportation status of each bus rider.

### CROSS-REFERENCE TO RELATED APPLICATION

This application claims the benefit of U.S. Provisional Application No. 60/557,720 filed on Mar. 30, 2004. This related application is hereby incorporated by reference as if fully set forth herein.

### INTRODUCTION

The present invention generally pertains to a method and system for tracking individuals such as, but not limited to, riders of buses. The present invention also pertains to a related method of providing electronic queries/views and notifications concerning transportation and/or individual location status details.

### DISCUSSION

An average school district in the United States picks up, transfers and delivers over 2000 students daily. Larger districts transport significantly more students. Many of these school districts employ a logistics hub and spoke strategy where students are required to change buses in en route to school. This type of arrangement introduces several opportunities for students to miss their assigned buses or board the wrong bus. Additionally problematic to the transportation of students is the fact that small children, particularly those unaccustomed to routine bus travel, are often unsure as to which bus is the correct bus to board when leaving school.

The ability of a school district or parent to know that every child (or a particular child) has safely boarded the correct bus and exited at the correct stop is currently very limited. This disadvantage not only causes parental anxiety, but may also lead to danger for the student riders. For example, in the morning some students are required to wait for buses on the side of the road. This morning wait is necessarily sometimes in the dark and occurs in all kinds of weather. If the buses are running late (e.g., as a result of weather, equipment malfunction, or the like) the children are required to wait longer, thereby increasing the potential for injury from traffic, weather, or other harm.

School districts are under increasing pressure to provide a safe and successful learning experience. Due to ever increasing tightening of school budgets, it is not reasonable to expect additional funding for busing. Student transportation is already a very expensive requirement. A typical school district may transport 60% of its students to and from school at a cost of an estimated 10% of the entire district budget.

Typically, achieving logistics efficiencies in student transportation is difficult because bus routes run simultaneously, therefore leveraging assets (i.e., buses and drivers) is not possible. In commercial logistics, the enabler to finding more efficient logistics solutions is the availability of ‘actual’ day-to-day route performance and resource capacity data. This data is invaluable because it allows for detailed analysis of the ‘planned’ to the ‘actual’ transportation operation. This analysis typically identifies significant transportation cost reduction opportunities.

Accordingly, a need remains in the pertinent art for an improved method and system for tracking riders of buses and providing related electronic status queries and notifications.

### SUMMARY

It is a general object of the present invention to provide a method of tracking individuals such as, but not limited to student passengers on school buses.

It is another object of the present invention to provide student transit status over the internet.

It is a related object of the present invention to provide parents, guardians, school administrators and school transportation managers internet access to verify items such as, but not limited to, the following:
i. whether a specific child boarded a bus;
ii. whether a specific child arrived at school safety;
iii. whether a specific child exited a bus at the correct stop;
iv. the actual stop at which a specific child exited a bus;
v. the actual stop at which a specific child was picked up;
vi. the time a specific child or a route arrived at school;
vii. the time a specific child or a route exited/arrived at a stop;
viii. the time a specific child was picked up;
ix. whether a specific bus is running on schedule;
x. estimated time of arrival to a specific stop; and
xi. whether equipment breakdowns have occurred.

It is another object of the present invention to provide student specific transit status e-mails for exceptions to normally anticipated travel and specific information, to parents, guardians, school administrators and transportation managers. The exceptions and/or e-mail notifications may include, but are not limited to: route running late; student pick-up ETA; child not picked up; child exited at the incorrect stop; late drop-off; late pick-up; and preplanned route changes/reroutes. The specific information communicated may include: pick-up time changes; drop-off time changes; route duration time changes; route stop changes; and non-planned (dynamic) route changes/reroutes.

It is another object of the present invention to provide a mechanism for the bus driver/school district to manage the student passengers as follows:
i. identifying if a student is boarding the correct bus, and if not, alerting the driver to provide guidance to the student passenger;
ii. identifying if a student passenger is exiting the bus at the correct (planned) stop, and if not, alerting the driver to therefore manage the exception; and
iii. identifying if a student has boarded the bus but not exited as planned, and if not, alerting the driver to mange the exception at that time.

It is another object of the present invention to provide a mechanism for parents/guardians to document and communicate their child's planned passenger status for a specific day. In this regard, a parent or guardian can access a web page prior to the specific route dispatch and document if their child is not going to ride the bus on that specific day. Some of the specific applications of this data include: data to reconcile or administer student passenger school attendance; and data to re-route/optimize the daily routes based on the ‘actual’ planned passengers. The value of this optimization results in: reduced student passenger ride time; reduced actual driver paid time and costs; reduced benefit costs; reduced actual miles and cost; reduced fuel consumption; reduced risk for accident/injury; reduced depreciation of vehicles; the elimination of excess vehicles; and reduced maintenance costs.

After the pick-up of specific student passengers, the present invention provides a tool/mechanism for the optimization of bus routes based on actual passengers. The value of this benefit includes: reduced student passenger ride time; reduced actual driver paid time and costs; reduced benefit costs; reduced actual miles and cost; reduced fuel consumption; reduced risk for accident/injury; retardation of the depreciation of vehicles; the elimination of excess vehicles; and reduced maintenance costs.

It is another object of the present invention to provide a system which enables school districts and/or transportation managers the ability to measure ‘Actual Performance’ vs. ‘Planned Performance’ in the following areas: miles; transit time, stop time, total time; stops, and capacity (number of passengers).

This data comparison enables the potential reduction in transportation costs as follows: reduced actual driver paid time and costs; reduced benefits costs; reduced actual miles and cost; reduced fuel consumption; reduced risk for accident/injury; retardation of the depreciation of vehicles; the elimination of excess vehicles; and reduced maintenance costs.

It is another object of the present invention to provide a mechanism to capture ‘Actual’ driver time for payroll purposes.

It is another object of the present invention to provide a mechanism to capture and analyze route delay exceptions, as they impact driver pay and overall route/network performance.

In one form, the present invention relates to a method for tracking a plurality of bus riders by assigning each bus rider with a unique identifier upon boarding a bus to indicate a transportation status and by recording the unique identifier upon exiting the bus to update the transportation status of each bus rider.

In another particular form, the present invention provides a method of tracking a plurality of riders on a bus. The method includes the step of creating a database associated with a remote computer system. The database includes anticipated rider data for each rider of the plurality of riders. The method additionally includes the steps of assigning each rider of the plurality of riders with a unique identifier, reading the unique identifiers for the plurality of riders, capturing actual rider data for each rider of the plurality of riders, electronically transmitting actual rider data for each rider of the plurality of riders to the remote computer system, and comparing actual rider data with anticipated rider data for each rider of the plurality of riders. The method further includes the steps of identifying an exception for each rider of the plurality of riders for which anticipated rider data and actual rider data differ and issuing a message to a responsible person associated with each rider of the plurality of riders for which an exception was identified advising the associated responsible person of the exception.

In yet another form the present invention provides a related system of tracking a plurality of riders of a bus. The system includes a database associated with a remote computer system. The database including anticipated rider data for each rider of the plurality of riders. The system additionally includes a unique identifier associated with each rider of the plurality of riders, means for reading the unique identifiers for the plurality of riders as the riders board and depart the bus, means for capturing actual rider data for each rider of the plurality of riders upon reading of the unique identifiers, and means for electronically transmitting actual rider data for each rider of the plurality of riders to the remote computer system. The remote computer system includes means for comparing actual rider data with anticipated rider data for each rider of the plurality of riders, means for identifying an exception for each rider of the plurality of riders for which anticipated rider data and actual rider data differ, and means for issuing a message to a responsible person associated with each rider of the plurality of riders for which an exception was identified advising the associated responsible person of the exception.

Further areas of applicability of the present invention will become apparent from the detailed description provided hereinafter. It should be understood that the detailed description and specific examples, while indicating one exemplary embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating a system for tracking individuals and providing related electronic notifications according to the present invention.

FIG. 2 is a flow chart generally illustrating the operation of a method for tracking individuals and providing related electronic notifications according to the present invention.

### DETAILED DESCRIPTION

The following description of the embodiment(s) of the invention is merely exemplary in nature and is in no way intended to limit the invention, its application, or uses. The present invention will be described with reference to an exemplary application. More specifically, the present invention will be described as applied to the tracking of riders of buses. Those skilled in the art will appreciate that certain teachings of the present invention have application beyond the exemplary application described. For example, it will become apparent below that the teachings of the present invention may alternatively be used to track students' travel between multiple classrooms during the course of a school day.

A system and a method for tracking individuals (e.g. student riders) and providing related electronic notifications will be described below. In the following description, for the purposes of explanation, numerous specific details are set forth in order to provide a thorough understanding of the present invention. It will be apparent to one skilled in the art, however, that the present invention may be practiced without these specific details. In other instances, well-known structures and devices are shown in block diagram form in order to avoid unnecessarily obscuring the present invention.

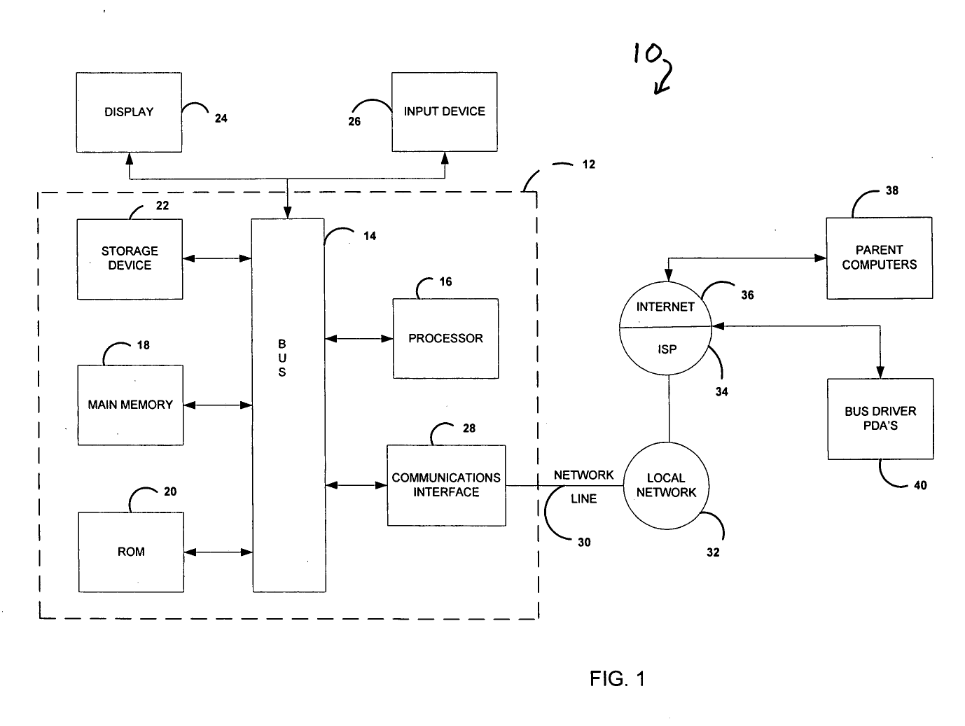

With initial reference to FIG. 1, a block diagram is provided illustrating a system 10 of the present invention. The system 10 is shown to generally include a computer system 12 upon which an embodiment of the invention may be implemented. The computer system 12 includes a bus 14 or other communication mechanism for communicating information, and a processor 16 coupled with the bus 14 for processing information. The computer system 12 also includes a main memory 18, such as a random access memory (RAM) or other dynamic storage device, coupled to the bus 14 for storing information and instructions to be executed by the processor 16. The main memory 18 also may be used for storing temporary variables or other intermediate information such as student information and bus route information during execution of instructions to be executed by processor 16. The computer system 12 further includes a read only memory (ROM) 20 or other static storage device coupled to the bus 14 for storing static information and instructions for the processor 16. A storage device 22, such as a magnetic disk or optical disk, is provided and coupled to bus 14 for storing information and instructions. Common examples of the computer system 12 include personal computers, workstations, minicomputers, servers, and mainframes.

The computer system 12 may be coupled via the bus 14 to a display 24 or monitor for displaying information to a computer user. An input device 26, including alphanumeric and other keys, is coupled to the bus 14 for communicating information and commanding selections to the processor 16.

The present invention is related to the use of the system 10 for tracking student bus riders. According to one embodiment of the invention, student tracking is provided by the system 10 in response to the processor 16 executing one or more sequences of one or more instructions contained in the main memory 18. Such instructions may be read into the main memory 18 from another computer-readable medium, such as the storage device 22. Execution of the sequences of instructions contained in the main memory 18 causes the processor 16 to perform the process steps described herein. In alternative embodiments, hard-wired circuitry may be used in place of or in combination with software instructions to implement the invention. Thus, embodiments of the invention are not limited to any specific combination of hardware circuitry and software.

The computer system 12 also includes a communication interface 28 coupled to the bus 14. The communication interface 28 provides a two-way data communication coupling to a network link 30 that is connected to a local network 32. For example, the communication interface 28 may be an integrated services digital network (ISDN) card or a modem to provide a data communication connection to a corresponding type of telephone line. As another example, the communication interface 28 may be a local area network (LAN) card to provide a data communication connection to a compatible LAN. Wireless links may also be implemented. In any such implementation, the communication interface 28 sends and receives electrical, electromagnetic or optical signals that carry digital data streams representing various types of information.

The network link 30 typically provides data communication through one or more networks to other data devices. For example, the network link 30 may provide a connection through the local network 32 to an Internet Service Provider (ISP) 34. The ISP 34 in turn provides data communication services through the worldwide packet data communication network, now commonly referred to as the “Internet” 36. The local network 32 and Internet 36 both use electrical, electromagnetic or optical signals that carry digital data streams.

The system 10 additionally includes a plurality of parent computers 38 and a plurality of personal digital assistants (PDAs). The plurality of parent computers, which are schematically and collectively illustrated at block 38, communicate in a conventional manner with the computer system 12 over the Internet 36. The plurality of PDAs, which are schematically and collectively illustrated at block 40, wirelessly communicate in a conventional manner with the computer system 12 over the Internet 36.

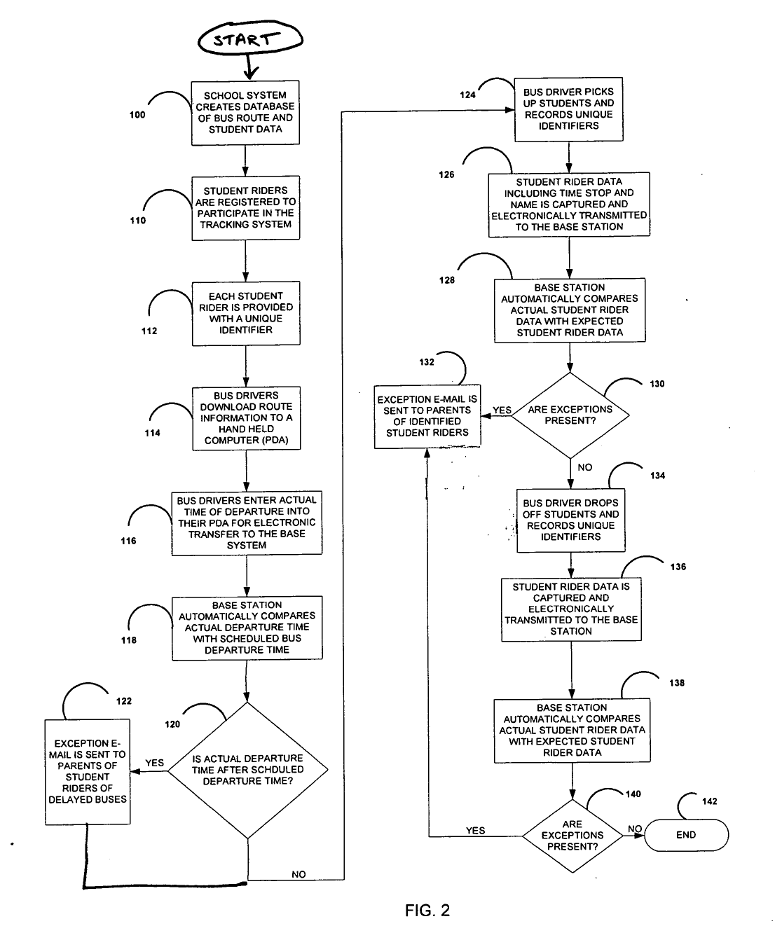

With continued reference to FIG. 1 and additional reference to FIG. 2, the method of the present invention will now be described. Beginning at “start,” in a first general step 100 of the present invention a school system provides bus route and student data which is entered into a computer database. The bus route data may include: required equipment type(s); assigned equipment number/identifier; route start times; route finish times; route start locations; individual stop locations/addresses; route finish locations; individual stop times; route end times; transit times; capacity/riders at each stop; other routes linked to the primary route (either before or after); and route numbers/identifiers. The school data may include; school locations/addresses, student's names; parent's names; guardian's names; pertinent relationships; student's, parent's and/or guardian's locations/addresses; individual/specific student's assigned pick-up bus route number/identifier; individual/specific student's drop-off bus route number/identifier; individual/specific student's assigned pick-up stop location/address; individual/specific student's drop-off stop location/address; individual/specific student's assigned school name; students current grade level; and parent's and/or guardian's contact information, such as, home phone numbers, work phone numbers, mobile phone numbers and e-mail addresses.

According to the next general step 110 of the present invention, student riders are registered to participate in the tracking system. In this regard, parents register their student rider(s) for tracking. Registration may be accomplished via the internet, fax or at the school. Registration may be associated with a registration fee that may be used to offset expenses associated with implementation or maintenance of the system 10.

According to the next general step 112 of the present invention, each student rider is provided with a unique identifier. According to one application, the unique identifier is a barcode bus pass. Other unique identifiers, including but not limited to a magnetically encoded card or a radio frequency card/chip may be alternatively employed.

According to the next general step 114 of the present invention, each morning the bus drivers download their route information to PDA. Alternately, the PDA may operate via wireless Internet connection, as an active web page eliminating the need to download the daily route data to the PDA.

According to the next general step 116 of the present invention, the bus driver enters the actual time of departure into their PDA for electronic transfer to the base system 12. If the bus departs late, identified by the download time, the system is updated with a new ETA. Alternately, the identification of a late departure can also be manually updated.

According to the next general step 118, the base station or base system 12 automatically compares the actual departure time with the planned or scheduled departure time.

According to decision block 120, if the actual departure time is after the scheduled departure time, the method progresses to block 122. Here, an exception e-mail is electronically sent (e.g., e-mailed) to parents of student riders of delayed buses. As used herein, the term “exception” may be defined as any actual event that deviates from an expected event based on predetermined business rules. The system may automatically request receipt notification.

Returning to decision block 120, if the actual departure time is not after the departure time, the method of the present invention progresses to block 124. Here, the bus driver picks up the students and records the unique identifier of each student.

In this regard, the time, stop and rider names are recorded when the student riders are picked up by driver scanning of the barcode bus passes or alternate unique identifier.

According to the next general step 128, the base station 12 automatically compares actual student rider data with expected student rider data. Exceptions are identified where the actual student data is different than the planned or expected student data. For example, if the database expects a particular student to be picked up at a particular stop and that particular student's unique identifier is not entered at that particular stop, an exception is created.

In decision block 130, if exceptions are present, the method progresses to block 132. Here, an exception e-mail is sent to parents of identified student riders. In the example above, an exception e-mail (or voice message) would be sent to the particular student's parent that failed to board the bus as anticipated notifying the parent of the missed bus. Alternatively, the base computer 12 can automatically issue a phone message from a preselected group of recorded phone messages. In this regard, in a conventional manner, the system 12 can automatically dial a phone number associated with the particular student rider and deliver a specific prerecorded message.

If exceptions are not present, the method of the present invention proceeds to block 134. In this general step, the bus driver drops off students and again records unique identifiers.

According to the next general step 136, student rider data such as, but not limited to, the drop off time and student names may be captured and transmitted to the base station 12.

According to the next general step 138 of the present invention, the base station 12 automatically compares actual student rider data with expected student rider data.

In decision block 140, if exceptions are present, the method progresses to block 132. Again, an exception e-mail (or voice message) would be sent to the particular student's parent advising them of the particular exception. If exceptions are not present, the method of the present invention proceeds to end 142.

The description of the invention is merely exemplary in nature and, thus, variations that do not depart from the gist of the invention are intended to be within the scope of the invention. Such variations are not to be regarded as a departure from the spirit and scope of the invention.

1. A method of tracking a plurality of bus riders, the method comprising:
assigning each bus rider of the plurality of bus riders with a unique identifier;
recording the unique identifier of each bus rider upon boarding a bus to indicate a transportation status of each bus rider; and
recording the unique identifier of each bus rider upon exiting the bus to update the transportation status of each bus rider.

2. The method of tracking a plurality of bus riders of claim 1, wherein the step of assigning each bus rider with a unique identifier includes the step of providing each bus rider with a barcoded bus pass.

3. The method of claim 2, wherein the step of recording the unique identifier of each bus rider upon boarding a bus includes the step of scanning the barcoded bus pass of each rider.

4. The method of claim 1, further comprising the step of automatically issuing an e-mail notification to a responsible adult upon identification of a transportation exception for one of the bus riders.

5. The method of claim 1, further comprising the step of automatically summarizing all student transportation status information, for specific riders or groups of riders, and making this summary information accessible via an internet web page.

6. A method of tracking a plurality of riders of a bus, the method comprising the steps of:
creating a database associated with a remote computer system, the database including anticipated rider data for each rider of the plurality of riders;
assigning each rider of the plurality of riders with a unique identifier;
reading the unique identifiers for the plurality of riders;
capturing actual rider data for each rider of the plurality of riders;
electronically transmitting actual rider data for each rider of the plurality of riders to the remote computer system;
comparing actual rider data with anticipated rider data for each rider of the plurality of riders;
identifying an exception for each rider of the plurality of riders for which anticipated rider data and actual rider data differ;
issuing a message to a responsible person associated with each rider of the plurality of riders for which an exception was identified advising the associated responsible person of the exception.

7. The method of tracking a plurality of riders of a bus of claim 6, wherein the step of assigning each rider of the plurality of riders with a unique identifier includes the step of assigning each rider of the plurality of riders with a bar code.

8. The method of tracking a plurality of riders of a bus of claim 6, further comprising the step of providing the bus with a computer for capturing the actual rider data for each rider of the plurality of riders.

9. The method of tracking a plurality of riders of a bus of claim 6, wherein the step of identifying an exception for each rider of the plurality of riders for which anticipated rider data and actual rider data differ includes the step of automatically identifying an exception for each rider of the plurality of riders for which anticipated rider data and actual rider data differ.

10. The method of tracking a plurality of riders of a bus of claim 6, wherein the step of issuing a message to a responsible person associated with each rider of the plurality of riders for which an exception was identified advising the associated responsible person of the exception includes the step of automatically issuing a message to a responsible person associated with each rider of the plurality of riders for which an exception was identified advising the associated responsible person of the exception.

11. The method of tracking a plurality of riders of a bus of claim 10, wherein the message is an e-mail message.

12. The method of tracking a plurality of riders of a bus of claim 11, wherein the message is a telephone message.

13. A system of tracking a plurality of riders of a bus, the system comprising:
a database associated with a remote computer system, the database including anticipated rider data for each rider of the plurality of riders;
a unique identifier associated with each rider of the plurality of riders;
means for reading the unique identifiers for the plurality of riders as the riders board and depart the bus;
means for capturing actual rider data for each rider of the plurality of riders upon reading of the unique identifiers; and
means for electronically transmitting actual rider data for each rider of the plurality of riders to the remote computer system;
wherein the remote computer system includes:
means for comparing actual rider data with anticipated rider data for each rider of the plurality of riders;
means for identifying an exception for each rider of the plurality of riders for which anticipated rider data and actual rider data differ; and
means for issuing a message to a responsible person associated with each rider of the plurality of riders for which an exception was identified advising the associated responsible person of the exception.

14. The system of tracking a plurality of riders of a bus of claim 13, wherein the unique identifier associated with each rider is a bar code.

15. The system of tracking a plurality of riders of a bus of claim 13, wherein the means for capturing the actual rider data for each rider of the plurality of riders is a computer.

16. The system of tracking a plurality of riders of a bus of claim 13, wherein the means for comparing actual rider data with anticipated rider data for each rider of the plurality of riders is operative to automatically compare actual rider data with anticipated rider data for each rider of the plurality of riders.

17. The system of tracking a plurality of riders of a bus of claim 13, wherein the means for identifying an exception for each rider of the plurality of riders for which anticipated rider data and actual rider data differ is operative for automatically identifying an exception for each rider of the plurality of riders for which anticipated rider data and actual rider data differ.

18. The system of tracking a plurality of riders of a bus of claim 13, wherein the means for issuing a message to a responsible person associated with each rider of the plurality of riders for which an exception was identified advising the associated responsible person of the exception is operative for automatically issuing a message to a responsible person associated with each rider of the plurality of riders for which an exception was identified advising the associated responsible person of the exception.

19. The system of tracking a plurality of riders of a bus of claim 18, wherein the message is an e-mail message.

20. The system of tracking a plurality of riders of a bus of claim 18, wherein the message is a telephone message.
